(19) United States
(12) Patent Application Publication
(10) Pub. No.: US 2007/0053084 A1
(43) Pub. Date: Mar. 8, 2007

(54) Mirror accessory

(76) Inventor: David Eugene Scott, Charlotte, NC (US)

Correspondence Address: David E. Scott, 1801 Rozwood Dr., Charlotte, NC, 28216, US

(21) Appl. No.: 11/218,244

(22) Filed: Sep. 2, 2005

(51) Int. Cl. G02B 5/08

(52) U.S. Cl. 359/838

(57) ABSTRACT

A mirror accessory includes a mirror cover, a casing cover and an attachment portion. The mirror cover includes a first material. The casing cover includes a second material. The casing cover is attached to the mirror cover to form a receiving opening configured to receive the vehicle mirror. The attachment portion is disposed adjacent to the receiving opening to secure the mirror accessory to the vehicle mirror.

### BACKGROUND OF THE INVENTION

The present invention relates to a mirror accessory and, more particularly, to an accessory for use on an exterior vehicle mirror.

Vehicles such as, for example, automobiles, bicycles, motorcycles, etc., often include a mirror assembly. Bicycles and motorcycles often include a mirror assembly attached to a handlebar assembly. Vehicles including automobiles and other motorized vehicles often include a mirror assembly disposed at an exterior of the vehicles. Such a mirror assembly often functions to provide a reflective surface to allow an operator of a vehicle to view an area behind the vehicle while the operator faces forward with respect to the vehicle.

The mirror assembly includes, for example, a mirror having a reflective face on one side of the mirror. The mirror is disposed proximate to a mirror casing such that the mirror casing encloses all portions of the mirror except the reflective face. The reflective face typically faces a rear portion of the vehicle and the mirror casing substantially faces a front portion of the vehicle. The mirror casing is attached to the vehicle by a mirror arm which extends from a surface of the vehicle to engage the mirror casing. The mirror casing may enclose mirror controls that allow a vehicle operator to control a position of the reflective face remotely. The mirror controls often extend through the mirror arm to the mirror casing and engage a portion of the mirror opposite of the reflective face.

A common problem encountered with the mirror assembly occurs when substances such as, for example, mud, dirt, pollution, frost, ice, snow etc., build up on the reflective face. When such substances build up on the reflective face, the reflective face may not be useful to allow the operator to view the area behind the vehicle. Thus, the operator may be required to scrape or otherwise remove the substances from the reflective face. Scraping the substances from the reflective face may be time consuming or even cause damage to the mirror assembly. Additionally, the substances may affect operation of the mirror controls to degrade performance of the mirror assembly.

Some vehicles include mirror controls having heating elements that may remove some of the substances, however, such heating elements require additional expense to install and maintain. Thus, there is a need for a mirror accessory that prevents the above-mentioned problems.

### BRIEF DESCRIPTION OF THE INVENTION

Exemplary embodiments of the invention include a mirror accessory. The mirror accessory includes a mirror cover, a casing cover and an attachment portion. The mirror cover includes a first material. The casing cover includes a second material. The casing cover is attached to the mirror cover to form a receiving opening configured to receive the vehicle mirror. The attachment portion is disposed adjacent to the receiving opening to secure the mirror accessory to the vehicle mirror.

Further exemplary embodiments of the invention include a mirror accessory for a vehicle mirror. The mirror accessory includes a mirror cover, a casing cover and an attachment portion. The mirror cover is configured to be disposed adjacent to a reflective face of the vehicle mirror and includes a first material. The casing cover includes a second material. The casing cover is configured to be disposed adjacent to a mirror casing of the vehicle mirror. The casing cover is attached to the mirror cover to form a receiving opening configured to receive the vehicle mirror. The attachment portion is disposed adjacent to the receiving opening. The attachment portion contacts a sidewall surface of the vehicle mirror to secure the mirror accessory to the vehicle mirror. The sidewall surface is disposed between a mirror arm of the vehicle mirror and the reflective face.

Still further exemplary embodiments of the invention include a mirror accessory for a mirror assembly. The mirror assembly includes a reflective face, a mirror casing and a mirror arm. The mirror accessory includes a mirror cover, a casing cover, an attachment portion and an engaging device. The mirror cover is configured to be disposed adjacent to the reflective face. The mirror cover includes a first material. The casing cover is configured to be disposed adjacent to the mirror casing. The casing cover includes a second material. The casing cover is attached to the mirror cover to form a receiving opening configured to receive the mirror assembly. The attachment portion is disposed adjacent to the receiving opening. The attachment portion is configured to contact a sidewall surface of the mirror assembly to secure the mirror accessory to the mirror assembly. The sidewall surface is disposed between the mirror arm and the reflective face. The engaging device is disposed to secure the attachment portion to the casing cover.

The above, and other objects, features and advantages of the present invention will become apparent from the following description read in conjunction with the accompanying drawings, in which like reference numerals designate the same elements.

### BRIEF DESCRIPTION OF THE DRAWINGS

Referring now to the drawings wherein like elements are numbered alike in the several FIGURES:

FIG. 1 shows a mirror assembly attached to an exterior surface of a vehicle;

FIG. 2 shows a perspective view of a mirror accessory according to an exemplary embodiment;

FIG. 3 shows a perspective view of the mirror accessory attached to the mirror assembly according to an exemplary embodiment; and

FIG. 4 is a perspective view of the mirror accessory showing an expressive device attached to a casing cover according to an exemplary embodiment.

### DETAILED DESCRIPTION OF THE INVENTION

Embodiments of the present invention will be described more fully hereinafter with reference to the accompanying drawings in which exemplary embodiments of the invention are shown. The present invention may, however, be embodied in different forms and should not be construed as being limited to the embodiments set forth herein. Rather, these exemplary embodiments are provided so that this disclosure will be thorough and complete, and will fully convey the scope of the invention to those skilled in the art. In the drawings, the size and shape of regions may be exaggerated for clarity. Like reference numerals refer to like elements throughout.

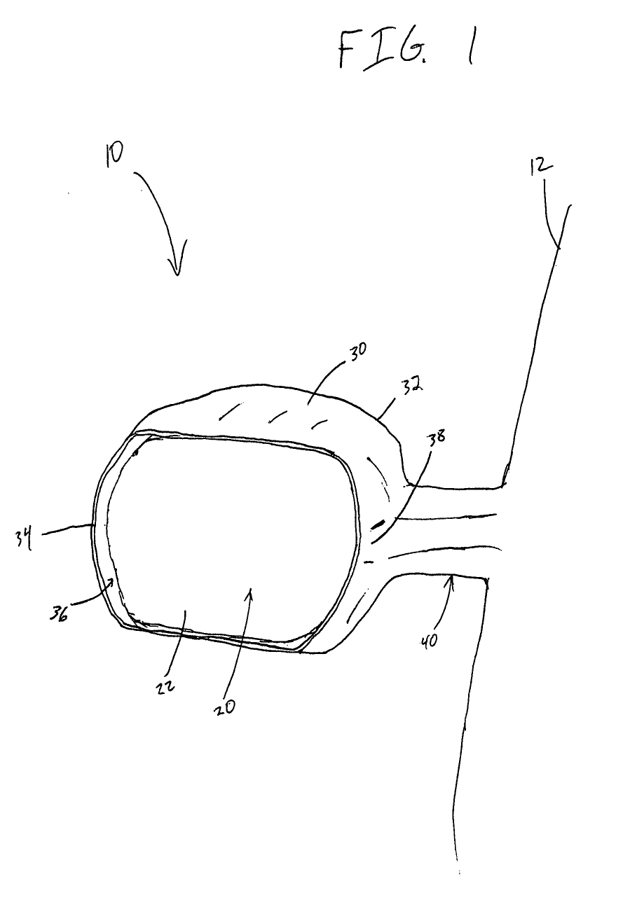

FIG. 1 shows a mirror assembly 10 attached to an exterior surface of a vehicle 12. Although the exterior surface of the vehicle 12 shown in FIG. 1 is a door of an automobile, it should be noted that any other surface of a vehicle may be used and any other vehicle including, for example, a bicycle, a motorcycle, a motorized vehicle, etc. is also envisioned.

Referring to FIG. 1, the mirror assembly 10 includes a mirror 20, a mirror casing 30 and a mirror arm 40. The mirror 20 includes a reflective face 22 which provides a surface suitable to allow an operator of the vehicle to view an optical reflection. In an exemplary embodiment, the reflective face 22 includes a flat reflective surface. Alternatively, the reflective face 22 may include a slightly concave or convex surface. A shape of the flat reflective surface of the reflective face 22 may be any suitable shape. For example, the shape of the flat reflective surface of the reflective face 22 may be substantially rounded, rectangular, square, or a combination of rounded, square and rectangular portions.

The mirror casing 30 includes a closed end portion 32 and an open end portion 34. The closed end portion 32 is disposed to face a forward end of the vehicle and may have numerous shapes. The closed end portion 32 may include, for example, a shape of a slightly flattened hemisphere. The open end portion 34 includes a receiving space 36. The receiving space 36 is shaped to correspond to a shape of the flat reflective surface of the reflective face 22. Mirror controls (not shown) and the mirror 20 may be inserted into a hollow portion of the closed end portion 32 such that the mirror controls allow positioning of the reflective face 22 of the mirror 20 remotely by an operator. Alternatively, the mirror 20 may be manually positioned by the operator, for example, via rotation of the mirror assembly 10 using the mirror arm 40. The mirror 20 is disposed within the receiving space 36 of the open end portion 34 such that the mirror casing encloses all portions of the mirror 20 except for the reflective face 22.

The mirror arm 40 may include, for example, a substantially cylindrical hollow body that extends from the exterior surface of the vehicle 12. The mirror arm 40 extends from the exterior surface of the vehicle 12 to a surface of the closed end portion 32 to attach the mirror assembly 10 to the vehicle. A sidewall surface 38 is formed at portion of the closed end portion 32 that is adjacent to the mirror arm 40. The sidewall surface 38 is a substantially flat surface disposed at a portion of the closed end portion 32 between the mirror arm 40 and the open end portion 34.

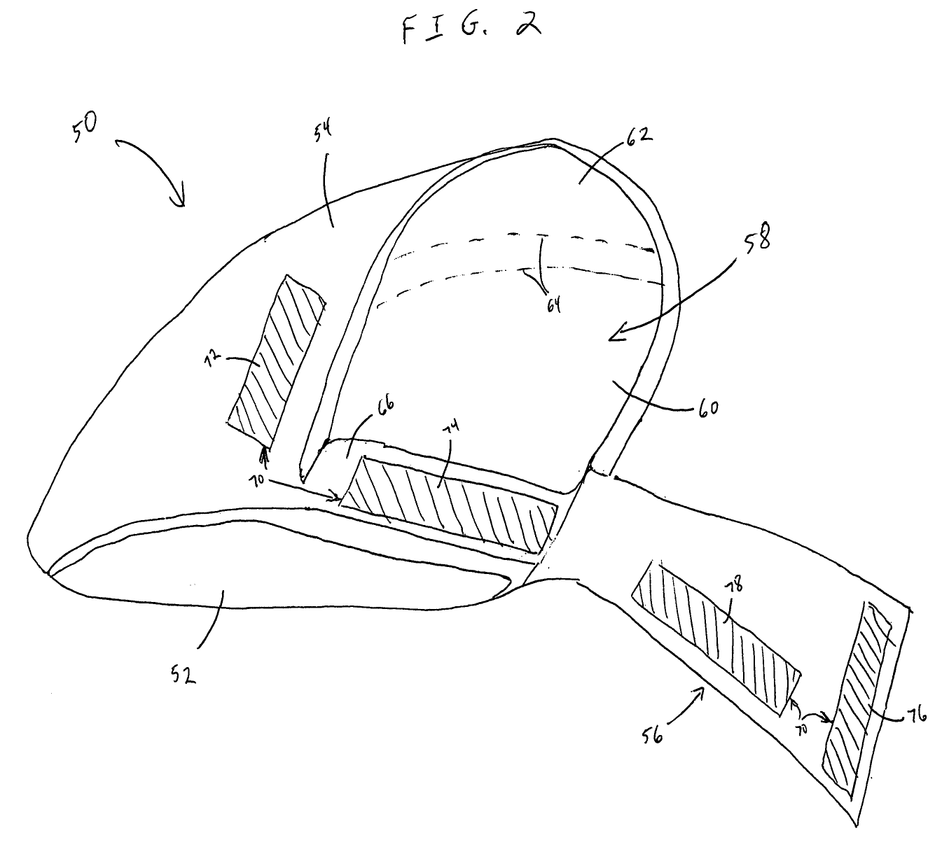

FIG. 2 shows a perspective view of a mirror accessory 50 according to an exemplary embodiment of the present invention. The mirror accessory 50, or mirror mitten, includes a mirror cover 52, a casing cover 54, and an attachment portion 56. The mirror accessory 50 is formed to correspond to a shape of an exterior of the mirror assembly 10, such that the mirror accessory 50 may be installed to substantially cover the mirror assembly 10. Thus, the mirror accessory 50 provides a snug fit over the mirror assembly 10. In other words, the mirror accessory 50 fits over the mirror assembly 10 with a glove-like or mitten-like fit. The mirror accessory 50 further includes a receiving opening 58 formed by the mirror cover 52, the casing cover 54 and the attachment portion 56.

The mirror cover 52 includes a material disposed substantially in a plate shape. The mirror cover 52 is shaped to substantially correspond to a shape of the reflective face 22.

The casing cover 54 includes a material disposed to initially extend substantially perpendicularly from edges of the mirror cover 52. The material of the casing cover 54 then extends from the edges of the mirror cover 52 to correspond substantially to a shape of the mirror casing 30. The material of the casing cover 54 may be fastened to the material of the mirror cover 52 by any suitable means including, for example, stitches, adhesives, etc. In an exemplary embodiment, the casing cover 54 includes a first portion 60 and a second portion 62 that may be combined together by, for example, stitches 64. The first portion 60 extends from a portion of an edge of the mirror cover 52. The second portion 62 extends from remaining portions of the edge of mirror cover 52. The first and second portions 60 and 62 combine to form the casing cover 54 having a substantially same shape as that of the mirror casing 30.

The attachment portion 56 extends from the first portion 60 and is disposed adjacent to the receiving opening 58. An engagement flap 66 forms a portion of the first portion 60 that is disposed between the receiving opening 58 and the mirror cover 52. In response to disposing the mirror accessory 50 over the mirror assembly 10, the engagement flap 66 is disposed adjacent to the sidewall surface 38. The attachment portion 56 is bendable to allow the attachment portion 56 to contact the engagement flap 66 to allow the mirror accessory 50 to be secured to the mirror assembly 10 via an engaging device 70. Although the attachment portion 56 is shown to secure the mirror accessory 50 to the mirror assembly 10 via the engagement flap 66 having a secured fitting with the sidewall surface 38, it should be noted that the attachment portion 56 may alternatively be wrapped around the mirror arm 40 in order to secure the mirror accessory 50 to the mirror assembly 10.

In an exemplary embodiment, the engaging device 70 includes a first engaging device 72, a second engaging device 74, a third engaging device 76 and a fourth engaging device 78. The first engaging device 72 is disposed at a portion of the second portion 62 of the casing cover 54 corresponding to an overlap between the attachment portion 56 and the second portion 62 when the attachment portion 56 is disposed to contact the engagement flap 66. The second engaging device 74 is disposed at the engagement flap 66. In an exemplary embodiment, a longitudinal direction of the first engaging device 72 is disposed substantially perpendicular to a longitudinal direction of the second engaging device 74. In other words, the first and second engaging devices 72 and 74 are disposed to form an L-shape. The third engaging device 76 is disposed at an interior side of the attachment portion 56 at an end portion of the attachment portion 56. The third engaging device 76 is disposed to correspond to the first engaging device 72 such that the first and third engaging devices 72 and 76 attach to each other when the attachment portion 56 is disposed to contact the engagement flap 66. The fourth engaging device 78 is disposed at the interior side of the attachment portion 56. The fourth engaging device 78 is disposed to correspond to the second engaging device 74 such that the second and fourth engaging devices 74 and 78 attach to each other when the attachment portion 56 is disposed to contact the engagement flap 66. In an exemplary embodiment, a longitudinal direction of the third engaging device 76 is disposed substantially perpendicular to a longitudinal direction of the fourth engaging device 78. In other words, the third and fourth engaging devices 76 and 78 are disposed to form an L-shape.

In an exemplary embodiment, the engaging device 70 includes a hook-and-loop fastener. Alternatively, the engaging device 70 may include other fasteners including, but not limited to snaps, zippers, adhesives, elastic bands, buttons, etc.

The material of the casing cover 54 and the material of the mirror cover 52 may be a same material. Alternatively, the material of the casing cover 54 and the material of the mirror cover 52 may be a different material. The material of the casing cover 54 may, for example, include leather, vinyl, plastic, canvas, etc. The material of the mirror cover 52 may include, for example, leather, vinyl, clear plastic, canvas, etc. In an exemplary embodiment, the mirror cover 52 is made of a transparent material, such as clear plastic, to allow the operator to view the reflective face 22 through the mirror cover 52 and the casing cover 54 is made of leather. Such an exemplary embodiment has the advantage of preventing a buildup of foreign substances on the reflective face 22, while maintaining the reflective face 22 visible to the operator of the vehicle.

The mirror assembly 10 may be disposed through the receiving opening 58 such that the reflective face 22 corresponds to the mirror cover 52 and the reflective face 22 is visible via the mirror cover 52. Additionally, the casing cover 54 corresponds to the mirror casing 30 and the engagement flap 66 corresponds to the sidewall surface 38. When the mirror assembly 10 is disposed through the receiving opening 58 as described above, the mirror arm 40 extends through the receiving opening 58.

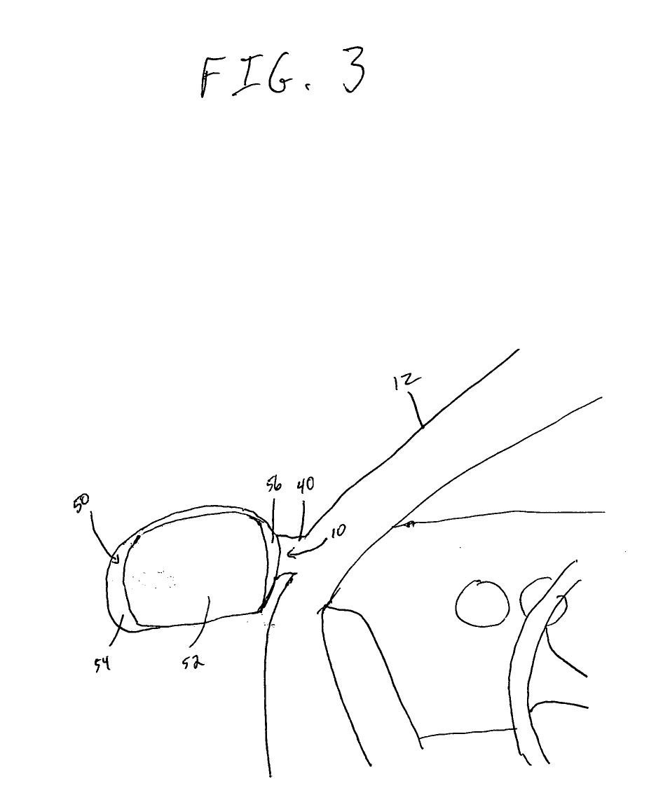

FIG. 3 shows a perspective view of the mirror accessory 50 attached to the mirror assembly 10 according to an exemplary embodiment. As shown in FIG. 3, the mirror accessory 50 is disposed to fit over the mirror assembly 10 with a mitten-like fit. In other words, the casing cover 54 corresponds to the mirror casing 30, the mirror cover 52 corresponds to the reflective face 22, and the attachment portion 56 corresponds to the sidewall surface 38.

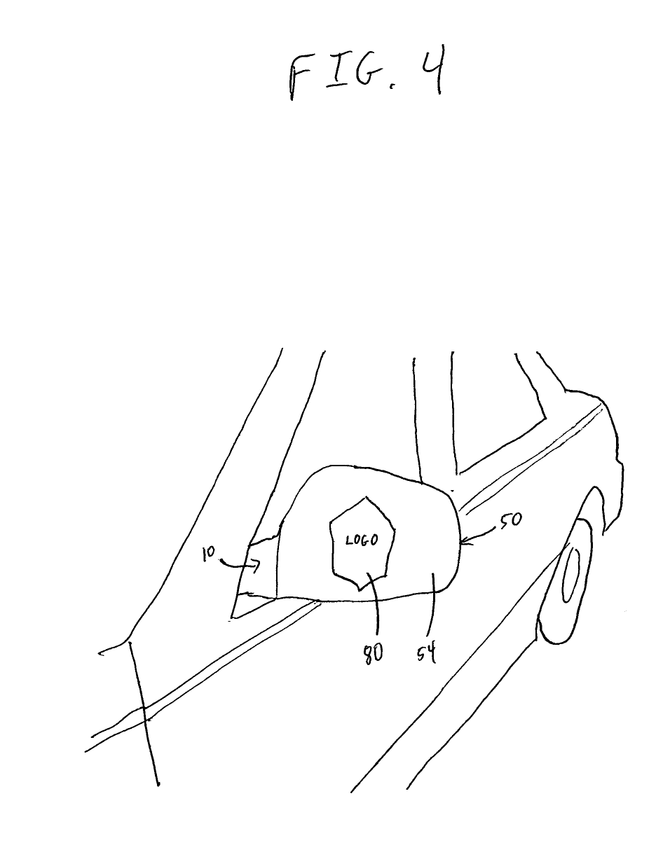

FIG. 4 is a perspective view of the mirror accessory showing an expressive device 80 attached to the casing cover 54 according to an exemplary embodiment. The expressive device 80 may function to provide a space for advertisement, expressive messages, logos, personalized messages, etc. disposed on the casing cover 54. The expressive device 80 may be attached to the casing cover 54 via, for example, stitching, adhesive, etc. The expressive device 80 may cover all of the casing cover 54, or a portion of the casing cover 54.

The present invention may exhibit some or all of the following advantages when employed as described above. The mirror accessory 50 may prevent materials such as ice, frost, snow, mud, dirt, pollution, etc. from building up on the reflective face 22. The mirror accessory 50 may prevent foreign materials from entering the mirror casing 30 and interfering with operation of mirror controls. When the mirror accessory 50 employs a transparent material for the mirror cover 52, the above-described advantages may be achieved while still maintaining visibility of the reflective face 22. Additionally, the mirror accessory 50 may have various colors and styles to improve the aesthetic appeal of vehicle mirrors.

In addition, while the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A mirror accessory for a vehicle mirror, the mirror accessory comprising:
a mirror cover including a first material;
a casing cover including a second material, the casing cover attached to the mirror cover to form a receiving opening configured to receive the vehicle mirror; and
an attachment portion disposed adjacent to the receiving opening to secure the mirror accessory to the vehicle mirror.

2. The mirror accessory of claim 1, wherein the first material is transparent.

3. The mirror accessory of claim 1, wherein the second material is one of leather and vinyl.

4. The mirror accessory of claim 1, wherein the casing cover includes an engagement flap disposed between the receiving opening and the mirror cover.

5. The mirror accessory of claim 4, further comprising an engaging device disposed to provide attachment between the attachment portion and the casing cover.

6. The mirror accessory of claim 5, wherein the engaging device includes a first engaging device disposed at a portion of the casing cover and a second engaging device disposed at the engagement flap.

7. The mirror accessory of claim 6, wherein the attachment portion includes a third engaging device corresponding to the first engaging device and a fourth engaging device corresponding to the second engaging device, and the first and third engagement devices combine and the second and fourth engagement devices combine to secure the mirror accessory to the vehicle mirror.

8. The mirror accessory of claim 6, wherein the first and second engaging devices include a hook-and-loop fastener disposed in an L-shape and the third and fourth engaging devices include a hook-and-loop fastener disposed in an L-shape.

9. The mirror accessory of claim 1, wherein the mirror accessory is secured to the vehicle mirror by an engaging device including one of:
a hook-and-loop fastener;
a zipper;
a button assembly;
a snap assembly; and
an elastic band.

10. The mirror accessory of claim 1, wherein the casing cover includes an expressive device.

11. A mirror accessory for a vehicle mirror, the mirror accessory comprising:
a mirror cover configured to be disposed adjacent to a reflective face of the vehicle mirror, the mirror cover including a first material;
a casing cover configured to be disposed adjacent to a mirror casing of the vehicle mirror, the casing cover including a second material, the casing cover attached to the mirror cover to form a receiving opening configured to receive the vehicle mirror; and
an attachment portion disposed adjacent to the receiving opening, the attachment portion contacting a sidewall surface of the vehicle mirror to secure the mirror accessory to the vehicle mirror, the sidewall surface being disposed between a mirror arm of the vehicle mirror and the reflective face.

12. The mirror accessory of claim 11, wherein the first material is transparent.

13. The mirror accessory of claim 11, wherein the second material is one of leather and vinyl.

14. The mirror accessory of claim 11, wherein the casing cover includes an engagement flap disposed between the receiving opening and the mirror cover.

15. The mirror accessory of claim 14, further comprising an engaging device disposed to provide attachment between the attachment portion and the casing cover.

16. The mirror accessory of claim 11, wherein the mirror accessory is disposed over the vehicle mirror such that the vehicle mirror is disposed in the receiving opening and the mirror accessory has a mitten-like fit over the vehicle mirror.

17. The mirror accessory of claim 11, wherein a shape of the mirror cover substantially corresponds to a shape of the reflective face and a shape of the casing cover substantially corresponds to a shape of the mirror casing.

18. A mirror accessory for a mirror assembly including a reflective face, a mirror casing and a mirror arm, the mirror accessory comprising:
a mirror cover configured to be disposed adjacent to the reflective face, the mirror cover including a first material;
a casing cover configured to be disposed adjacent to the mirror casing, the casing cover including a second material, the casing cover attached to the mirror cover to form a receiving opening configured to receive the mirror assembly;
an attachment portion disposed adjacent to the receiving opening, the attachment portion configured to contact a sidewall surface of the mirror assembly to secure the mirror accessory to the mirror assembly, the sidewall surface being disposed between the mirror arm and the reflective face; and
an engaging device disposed to secure the attachment portion to the casing cover.

19. The mirror accessory of claim 18, wherein the mirror arm extends adjacent to the attachment portion at the receiving opening.

20. The mirror accessory of claim 18, wherein the engaging device is one of:
a hook-and-loop fastener;
a zipper;
a button assembly; and
a snap assembly.
